(19) United States
(12) Patent Application Publication
(10) Pub. No.: US 2010/0083049 A1
(43) Pub. Date: Apr. 1, 2010

(54) COMPUTER SYSTEM, METHOD OF DETECTING SYMPTOM OF FAILURE IN COMPUTER SYSTEM, AND PROGRAM

(75) Inventor: Takafumi MIKI, Fujisawa (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/510,288

(22) Filed: Jul. 28, 2009

(30) Foreign Application Priority Data
Sep. 29, 2008 (JP) 2008-250167

(51) Int. Cl. G06F 11/36; G06F 9/455

(52) U.S. Cl. 714/38; 714/37; 703/23; 714/E11.212

(57) ABSTRACT

Provided is a computer system comprising: a failure symptom detection unit for detecting a symptom of a failure in hardware of a computer based on a measurement of a sensor; and a plurality of the sensors each provided to a component of the hardware, for measuring a status quantity of the component. The failure symptom detection unit comprises: a failure symptom determination processing unit for obtaining, from a characteristic information for each application, an estimation of the status quantity of the each component, which corresponds to current load information, obtaining a current status quantity as a current value for the each component, and determining, when an absolute value of a difference between the estimation and the current value is equal to or more than a permissible error, that the symptom of the failure is present.

### CLAIM OF PRIORITY

The present application claims priority from Japanese patent application JP2008-250167 filed on Sep. 29, 2008, the content of which is hereby incorporated by reference into this application.

### BACKGROUND OF THE INVENTION

This invention relates to a technology of detecting a symptom of occurrence of a failure in hardware of a computer system, and more particularly, to a technology of detecting, by monitoring operation statuses of applications and outputs of sensors, a symptom of failure in hardware in an own computer.

As a method of detecting occurrence of a failure in hardware of a computer, there is widely known a method of measuring temperatures of a processor and chips, and determining, when a measurement of the temperature exceeds a threshold, that a failure has occurred.

When the computer is switched over after the failure has occurred, a suspension period of active services and the like extends, and thus, technologies of detecting a symptom leading to a failure of a computer have been proposed (for example, U.S. 2005/0081122A1). According to the conventional example disclosed in U.S. 2005/0081122A1, a plurality of OSes are simultaneously run, an application under one OS analyzes statuses of other active OSes and applications at any time, thereby detecting a symptom leading to a failure based on patterns set in advance.

### SUMMARY OF THE INVENTION

According to the above-mentioned conventional example disclosed in U.S. 2005/0081122A1, when a status of the OS or the application coincides with a symptom pattern of a failure set in advance, it is determined that there is a symptom of occurrence of a failure. The symptom patterns of failure include patterns in which interrupts frequently occur, in which execution of an application slows down, and in which the temperature of a processor is higher than that in a normal status, which is recorded in advance.

However, in the above-mentioned conventional example disclosed in U.S. 2005/0081122A1, there is a problem that a symptom of failure which does not coincide with the symptom patterns set in advance cannot be detected. In other words, in the above-mentioned conventional example, only known symptom patterns of failure are detected, and unknown symptoms of failures cannot be detected. In particular, it is difficult, for symptoms of failures in hardware caused by changes over time in a computer, to set symptom patterns in advance, and, for example, when a circuit component on a circuit board of the computer has degraded, a symptom of failure depends on the type of the circuit component and the location thereof on the circuit board, and an unexpected symptom may occur.

Moreover, according to the above-mentioned conventional example disclosed in U.S. 2005/0081122A1, it is determined that a symptom of failure is present when the temperature of the processor has risen compared with the temperature of the processor in the normal status, which has been recorded in advance, and hence when a plurality of applications imposing a load on the processor are executed, the temperature of the processor rises compared with the temperature in the normal status, resulting in a possible error in the detection of a symptom of failure.

Moreover, the normal status of the computer varies depending on the applications, and there are an application low in load imposed on the processor (usage) and high in load imposed by access to disks, an application low in load imposed by access to disks and high both in load imposed on the processor and load imposed by access to a main memory, and the like. In this way, the normal status of the computer varies depending on the types of applications, and hence the above-mentioned conventional example has a problem in proper determination of a symptom of failure according to the types of applications.

Moreover, the above-mentioned conventional example has a problem in easily identifying a location generating a symptom of failure. For example, even when frequent interrupts are detected as a symptom of failure, it is not possible to identify a location of the symptom of failure in the computer.

This invention has been made in view of the above-mentioned problems, and it is therefore an object of this invention to detect an unknown symptom of failure as well as a known symptom of failure, to thereby identify a location generating a symptom of failure, and to precisely detect a symptom of failure according to the types of applications.

To solve the problems, a computer system, comprising: a computer comprising: a processor for carrying out an arithmetic operation; and a memory for storing an application and an OS which are executed by the processor; a plurality of sensors each provided to a component of hardware of the computer, for measuring a status quantity of the component; and a failure symptom detection unit for detecting a symptom of a failure in the hardware based on a measurement of each of the plurality of sensors, wherein the failure symptom detection unit comprises: an operation information acquisition unit for acquiring, from the OS, load information on the processor used for the application; a sensor information processing unit for acquiring the measurement from the each of the plurality of sensors for each component; a characteristic data storage unit for associating, in advance, each load information on the processor when the application is executed and the measurement of the each of the plurality of sensors for the each component when the application is executed with each other, and storing the associated load information and the associated measurement as characteristic information on the application; a failure symptom determination processing unit for obtaining, from current load information acquired by the operation information acquisition unit and the characteristic information corresponding to the application, an estimation of the status quantity of the each component, which corresponds to the current load information, obtaining, from the sensor information processing unit, a current status quantity as a current value for the each component, and comparing, for the each component, an absolute value of a difference between the estimation and the current value with a permissible error set in advance, to thereby determine, when the absolute value of the difference is equal to or more than the permissible error, that the symptom of the failure is present; and a failed location determination processing unit for identifying the component having the absolute value of the difference equal to or more than the permissible error as a component in which the symptom of the failure is present.

Thus, according to this invention, it is possible to detect a symptom of failure according to the characteristics of the applications before the failure actually occurs for the respective components constituting the computer, and moreover, detect an unknown symptom of failure in addition to a symptom of failure expected in advance, which can also be detected by the above-mentioned conventional example. In particular, before a failure occurs in the hardware of the computer due to changes over time, a symptom of failure can be detected according to the characteristics of the applications, and further, a component generating the symptom of failure can be identified, and hence the computer can be easily maintained.

### BRIEF DESCRIPTION OF THE DRAWINGS

FIG. 1 shows a first embodiment of this invention, and is a block diagram of a server system to which this invention is applied.

FIG. 2 shows a first embodiment of this invention, and describes an example of the sensor information repository 114.

FIG. 3 shows a first embodiment of this invention, and describes an example of the operation information repository 115.

FIG. 4 shows a first embodiment of this invention, and describes an example of the characteristic data repository 116.

FIG. 5 shows a first embodiment of this invention, and is a chart illustrating an example of a result of the processing carried out by the failure symptom detection module 10.

FIG. 6 shows a first embodiment of this invention, and is a flowchart illustrating an example of processing carried out on the repository data processing module 110.

FIG. 7 shows a first embodiment of this invention, and is a flowchart illustrating an example of processing carried out on the operation information collection processing module 106.

FIG. 8 shows a first embodiment of this invention, and is a flowchart illustrating an example of processing of creating the characteristic data, which is carried out by the repository data processing module 110 and the characteristic data calculation processing module 107.

FIG. 9 shows a first embodiment of this invention, and is a flowchart illustrating an example of the first part of processing carried out on the failure symptom determination processing module 108.

FIG. 10 shows a first embodiment of this invention, and is a flowchart illustrating an example of the second part of processing carried out on the failure symptom determination processing module 108.

FIG. 11 shows a first embodiment of this invention, and is a flowchart illustrating an example of the final part of processing carried out on the failure symptom determination processing module 108.

FIG. 12 shows a first embodiment of this invention, and is a chart illustrating relationships between the processor usage of the application A 210 and time, and between the power consumption of the application A 210 and time.

FIG. 13 shows a first embodiment of this invention, and is a chart indicating the characteristic data of the application A 210, and the relationship between the processor usage and the power consumption.

FIG. 14 shows a first embodiment of this invention, and is a chart indicating the characteristic data of the application B 211, and the relationship between the processor usage and the power consumption.

FIG. 15 shows a first embodiment of this invention, and is a chart indicating the characteristic data of the application C 212, and the relationship between the processor usage and the power consumption.

FIG. 16 shows a second embodiment of this invention, and is a block diagram of a server system to which this invention is applied.

### DETAILED DESCRIPTION OF THE PREFERRED EMBODIMENTS

A description is now given of embodiments of this invention referring to accompanying drawings.

### First Embodiment

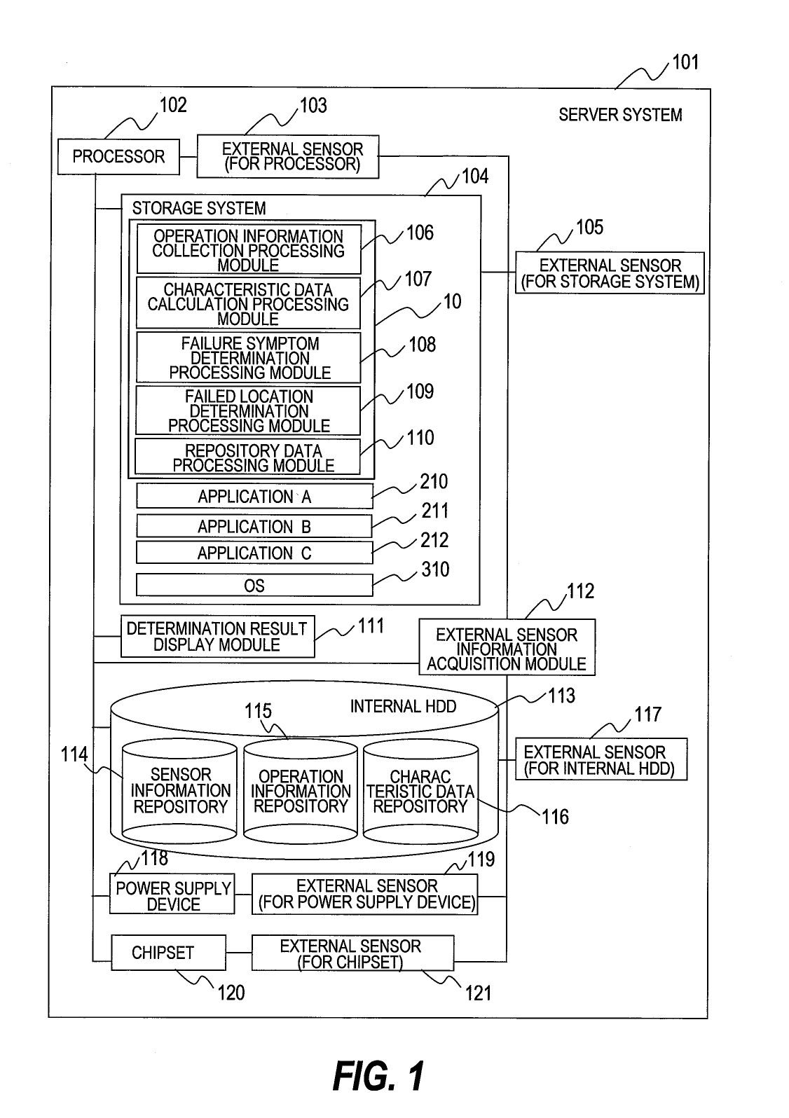

FIG. 1 illustrates a first embodiment of this invention, and is a block diagram of a server system (computer system) to which this invention is applied.

A server system 101 mainly includes a processor 102 for carrying out arithmetic operations, a storage system (memory) 104 for storing data and programs executed by the processor 102, an internal hard disk drive 113 for holding data and programs, a chipset 120 for coupling the processor 102, the storage system 104, the internal hard disk drive 113, and the like with one another, a power supply device 118 for supplying respective devices of the server system 101 with electric power, external sensors 103, 105, 117, 119, and 121 for measuring statuses of respective devices of the server system 101, an external sensor information acquisition module 112 for acquiring measurements from the respective external sensors, and a determination result display module 111 for displaying symptoms of failure and the like.

The external sensor includes a sensor for measuring a power consumption, and measures a supply voltage and a supply current to a device to be measured, thereby obtaining the power consumption from the product of the supply voltage and the supply current. The external sensor 103 measures the power consumption of the processor 102, and transmits, in response to a request from the external sensor information acquisition module 112, the measured power consumption. Similarly, the external sensor 105 measures the power consumption of the storage system 104; the external sensor 117, that of the internal hard disk drive 113; the external sensor 119, that of the power supply device 118; and the external sensor 121, that of the chipset 120. It should be noted that the external sensor may include widely-known voltage measurement circuit and current measurement circuit.

The plurality of external sensors are coupled to the external sensor information acquisition module 112. The external sensor information acquisition module 112, based on a request from a repository data processing module 110, which is described later, acquires measurements from the respective external sensors, and transmits the measurements to the repository data processing module 110.

The determination result display module 111 includes an interface for outputting information to a display device (not shown).

To the storage system 104 that includes memories, an operating system (OS) 310, an application A 210, an application B 211, and an application C 212 are loaded, and are executed by the processor 102. Moreover, to the storage system 104, as an application (or a service) for detecting a symptom of failure, a failure symptom detection module 10 is loaded, and is executed by the processor 102. It should be noted that the failure symptom detection module 10 includes a program, is held by the internal hard disk drive 113 serving as a machine-readable medium, is loaded to the storage system 104, and is executed by the processor 102.

The failure symptom detection module 10 includes the repository data processing module (sensor information processing module) 110 for acquiring the information (measurements) of the external sensors 103 to 121 (“103 to 121” implies “103, 105, 117, 119, and 121” hereinafter), and for storing the acquired information in the internal hard disk drive 113, an operation information collection processing module 106 for acquiring information on operation statuses of the applications A 210 to C 212 and the OS 310 running on the server system 101, and for storing the acquired operation information in the internal hard disk drive 113, a characteristic data calculation processing module 107 for calculating characteristic data according to the type of an application being executed on the server system 101, and for storing the calculated characteristic data in a characteristic data repository 116 of the internal hard disk drive 113, a failure symptom determination processing module 108 for, based on the information on the external sensors 103 to 121 acquired by the repository data processing module 110, the information on the operation statuses of the applications acquired by the operation information collection processing module 106, and the characteristic data set for the respective applications, detecting a symptom of failure in the server system 101, and a failed location determination processing module 109 for, when the failure symptom determination processing module 108 detects a symptom of failure, identifying a location having the symptom of failure in the server system 101.

In the internal hard disk drive 113, a sensor information repository 114 for storing information on the external sensors 103 to 121, an operation information repository 115 for storing the information on the operation statuses of the applications and the OS, and a characteristic data repository 116 for storing the characteristic data set in advance respectively for the applications A 210 to C 212.

The repository data processing module 110 requests the external sensor information acquisition module 112 for data for every predetermined period (such as one second), thereby acquiring the measurements of the external sensors 103 to 121. Then, the repository data processing module 110 converts the acquired measurements of the external sensors 103 to 121 into data to be stored in the sensor information repository 114, and stores the converted data into the sensor information repository 114.

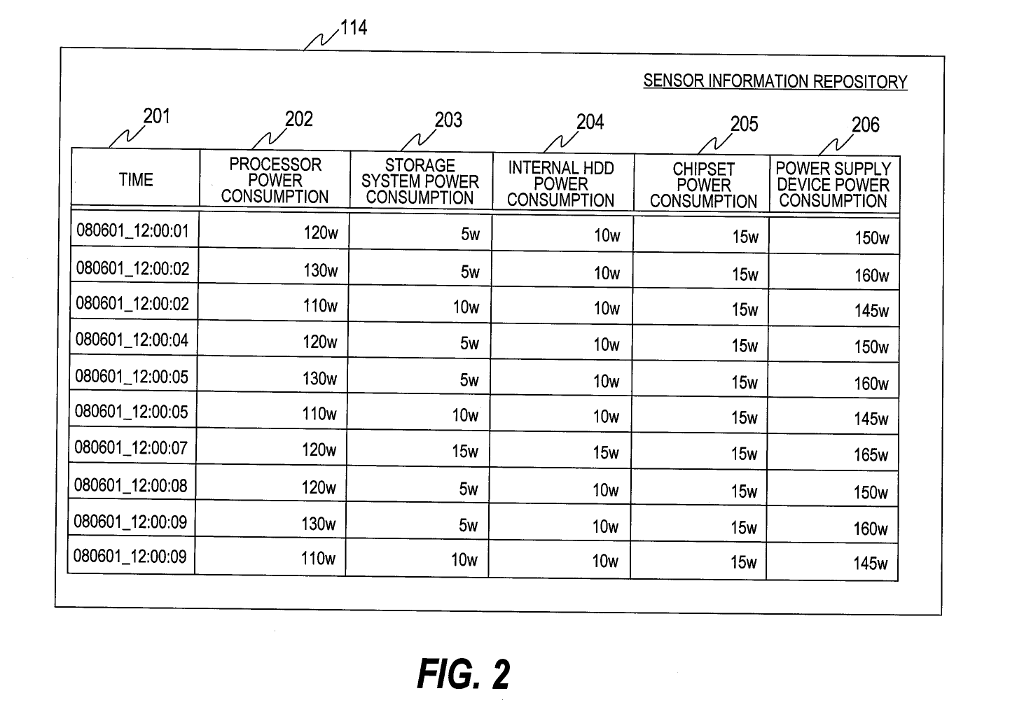

FIG. 2 describes an example of the sensor information repository 114. In FIG. 2, one entry of the sensor information repository 114 includes a time 201 for storing a timestamp indicating a time when the repository data processing module 110 acquires the information on the respective external sensors 103 to 121 from the external sensor information acquisition module 112, a processor power consumption 202 for storing the power consumption of the processor 102 measured by the external sensor 103, a storage system power consumption 203 for storing the power consumption of the storage system 104 measured by the external sensor 105, an internal HDD power consumption 204 for storing the power consumption of the internal hard disk drive 113 measured by the external sensor 117, a chipset power consumption 205 for storing the power consumption of the chipset 120 measured by the external sensor 121, and a power supply device power consumption 206 for storing the power consumption of the power supply device 118 measured by the external sensor 119.

The repository data processing module 110 converts the information acquired from the external sensors 103 to 121 into one entry of the sensor information repository 114, adds a timestamp to the entry, and writes the entry to the sensor information repository 114 of the internal hard disk drive 113.

The operation information collection processing module 106 acquires, for every predetermined period (such as one second) from the OS 310, a processor usage indicating the usage of the processor 102, a disk busy rate indicating the usage of the internal hard disk drive 113, and processor usages for the respective applications A to C as load information, and stores the information into the operation information repository 115.

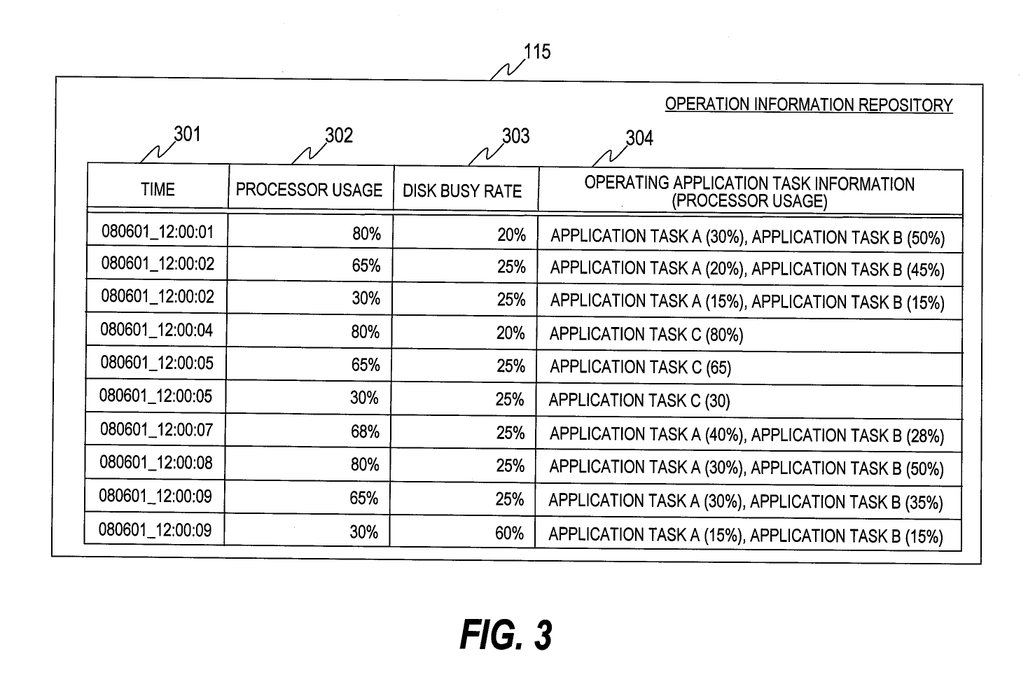

FIG. 3 describes an example of the operation information repository 115. In FIG. 3, one entry of the operation information repository 115 includes a time 301 for storing a timestamp indicating a time when the information on the operation statuses is acquired, a processor usage 302 for storing the processor usage measured by the OS 310, a disk busy rate 303 for storing the disk usage measured by the OS 310, and an operating application task information 304 for storing the processor usages for the respective applications A 210 to C 212.

On this occasion, the processor usage indicates a ratio of a period in which a process or a kernel processing occupies the processor 102 to a predetermined period, and is obtained by the OS 310. Moreover, the disk busy rate indicates a ratio of a period spent by the server system 101 for processing transfer requests to the internal hard disk drive 113 within a unit time, and is obtained by the OS 310. The operating application task information 304 indicates processor usages for the respective applications A 210 to C 212 running on the OS 310.

The characteristic data calculation processing module 107, as described later, collects in a test period before the actual operation of the server system 101, information on the operation statuses when the applications A 210 to C 212 are executed, obtains estimations (predictions) of the measurements of the respective external sensors 103 to 121 corresponding to the processor usages from the collected information, and stores the estimations into the characteristic data repository 116.

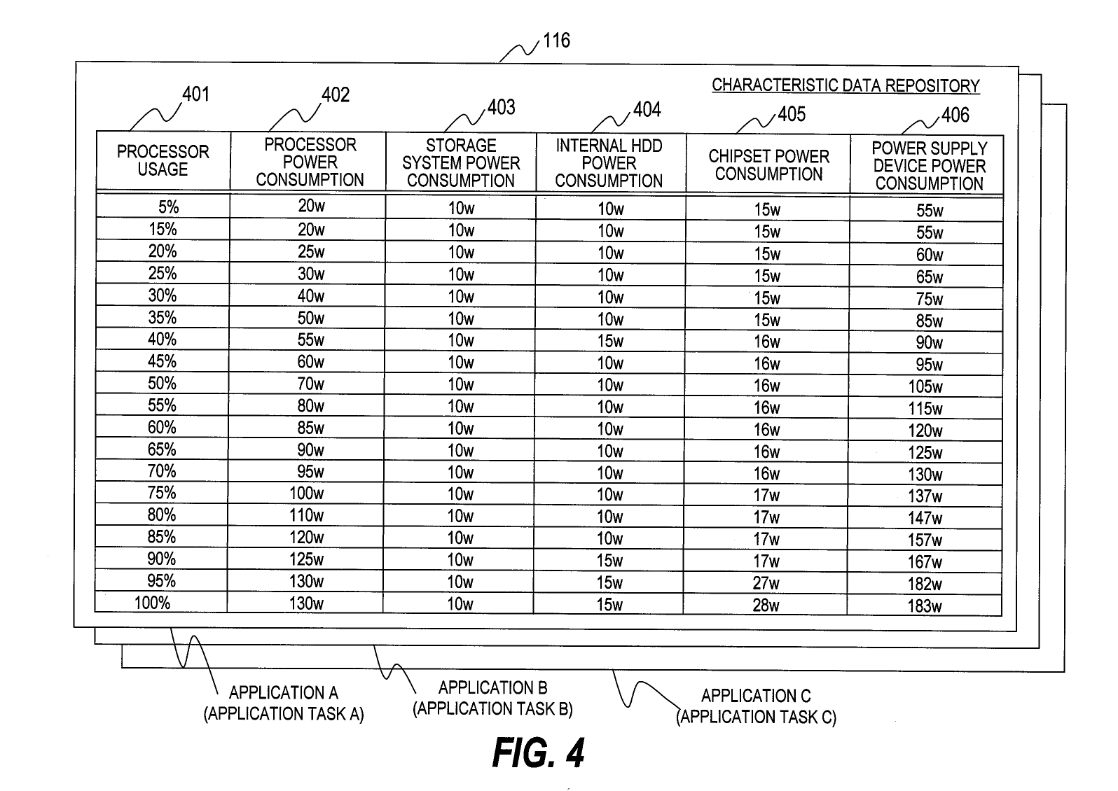

FIG. 4 describes an example of the characteristic data repository 116. To the characteristic data repository 116, for the applications A to C, the estimations of the power consumption of the respective devices corresponding to the processor usages are set in advance. In the example illustrated in FIG. 4, while the processor usages are set with an increment of 5%, the estimations of the power consumptions of the respective devices are set.

In FIG. 4, one entry of the characteristic data repository 116 includes a processor usage 401, a processor power consumption 402 for storing an estimation of the power consumption of the processor 102 corresponding to the processor usage 401, a storage system power consumption 403 for storing an estimation of the power consumption of the storage system 104 corresponding to the processor usage 401, an internal HDD power consumption 404 for storing an estimation of the power consumption of the internal hard disk drive 113 corresponding to the processor usage 401, a chipset power consumption 405 for storing an estimation of the power consumption of the chipset 120 corresponding to the processor usage 401, and a power supply device power consumption 406 for storing an estimation of the power consumption of the power supply device 118 corresponding to the processor usage 401.

The characteristic data repository 116 is set in advance respectively for the applications A to C. In an example illustrated in FIG. 4, pieces of the characteristic data for the application A are illustrated, but pieces of characteristic data (not shown) are set in advance for the applications B and C. The characteristic data includes, for example, from the characteristic data repository when the processor usage of the application A is 5%, the estimations of power consumption of the respective devices, which are represented as follows:

Estimation of power consumption of the processor 102: EPcpu=20 watts;

Estimation of power consumption of the storage system 104: EPmem=10 watts;

Estimation of power consumption of the internal hard disk drive 113: EPhdd=10 watts;

Estimation of power consumption of the chipset 120: EPtip=15 watts; and

Estimation of power consumption of the power supply device 118: EPpwr=55 watts.

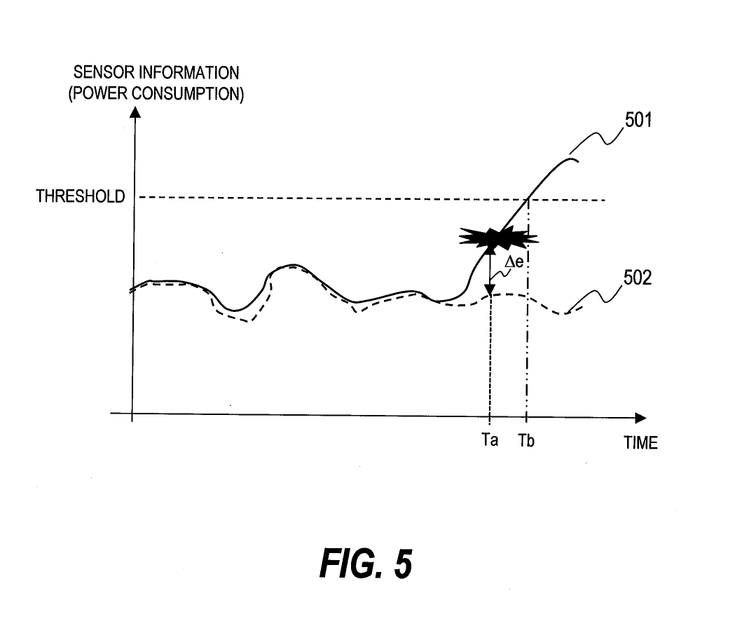

FIG. 5 is a chart illustrating an example of a result of the processing carried out by the failure symptom detection module 10. FIG. 5 is a chart illustrating a relationship between time and a measurement (power consumption) of an external sensor when the application A 210 is executed, and a relationship between time and an estimation of the power consumption obtained from the characteristic data for the application A stored in the characteristic data repository 116 according to the operation information obtained from the OS 310.

In FIG. 5, a solid line 501 represents the power consumption acquired from the external sensor, and is the power consumption of the processor 102 acquired by the external sensor 103, for example. A broken line 502 represents, with respect to time, the estimation of the power consumption of the processor 102 obtained by referring to the characteristic data stored in the characteristic data repository 116 corresponding to the processor usage of the application A 210.

The estimation 502 represents, when the measurement of the processor usage of the application A 210 is 25%, for example, the estimation of the processor power consumption 402 stored in an entry corresponding to the processor usage of 25% in the referenced characteristic data for the application A 210 stored in the characteristic data repository 116.

Then, the failure symptom determination processing module 108 determines, when an absolute value of a difference between the measurement 501 of one of the external sensors 103 to 121 in real time and the estimation 502 of the power consumption obtained from the characteristic data repository 116 is equal to or more than the permissible error Δe set in advance, that a symptom of failure is present, and notifies the failed location determination processing module 109 of the symptom. The failed location determination processing module 109 determines that a symptom of failure has been generated for a measurement target of the external sensor for which the symptom of failure has been detected, and outputs a result of the determination to the determination result display module 111. By comparing the absolute value of the difference between the measurement (current value) 501 and the estimation 502 with the predetermined permissible error Δe, it is possible to detect both a case in which the load imposed on a device to be monitored of the server system 101 has become excessively large, resulting in a symptom of failure, and a case in which the device is not functioning or a power is not supplied, and the load has thus decreased, resulting in a symptom of failure.

In the example illustrated in FIG. 5, at a time Ta, the absolute value of the difference between the measurement 501 of the power consumption and the estimation 502 of the power consumption of the processor 102 is equal to or more than the predetermined permissible error Δe, and thus, the failure symptom determination processing module 108 determines that the processor 102 has a symptom of failure. A threshold of FIG. 5 is a predetermined value for determining that a failure has actually occurred in the processor 102. In this example, while the failure symptom detection module 10 detects the symptom of failure at the time Ta, a time when the measurement 501 of the power consumption of the processor 102 exceeds the threshold and a failure actually occurs is Tb, and a warning is thus issued to an administrator or the like earlier by a difference Tb−Ta before failure occurs, and the location having the symptom of the failure can be notified to the administrator.

The failure symptom detection module 10 monitors whether or not the absolute value of the difference between the measurement 501 of the power consumption and the estimation 502 of the power consumption has become equal to or more than the permissible error Δe, and hence the failure symptom detection module 10 can detect unknown symptoms of failure in addition to known symptoms of failure.

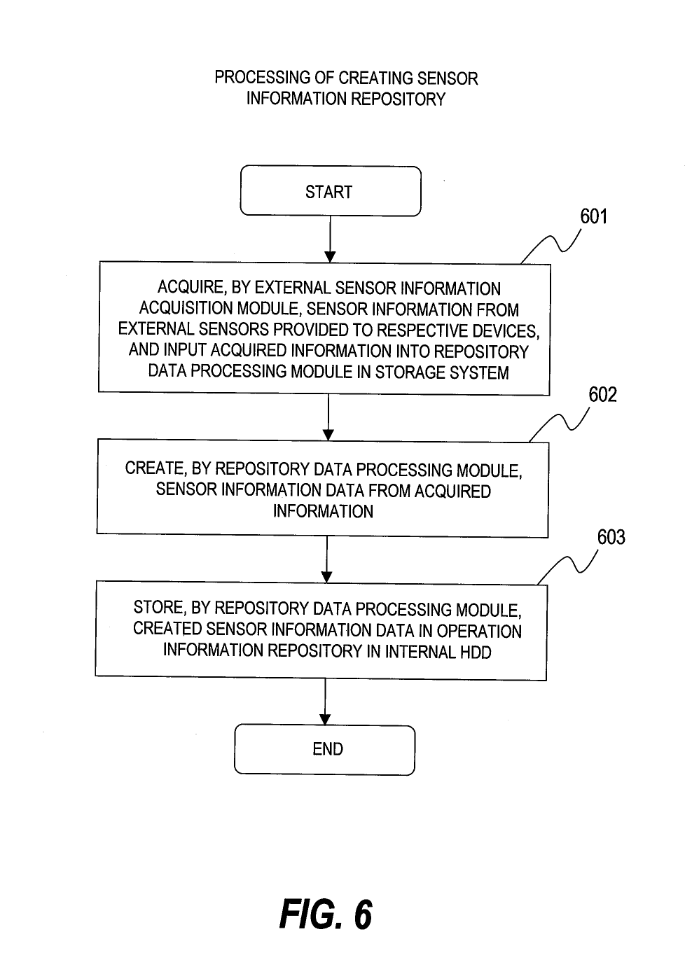

FIG. 6 is a flowchart illustrating an example of processing carried out on the repository data processing module 110. The repository data processing module 110 executes the processing represented by the flowchart of FIG. 6 for every predetermined period (such as one second).

In Step 601, the repository data processing module 110 requests the external sensor information acquisition module 112 for the measurements of all the external sensors 103 to 121 in the server system 101. The external sensor information acquisition module 112 receives the measurements of the respective external sensors 103 to 121, and returns the measurements to the repository data processing module 110. The repository data processing module 110 acquires the measurements of the respective external sensors 103 to 121 from the response from the external sensor information acquisition module 112.

In Step 602, as illustrated in FIG. 2, the repository data processing module 110 adds a timestamp 201 to the measurements of the respective external sensors 103 to 121 received from the external sensor information acquisition module 112, thereby creating the sensor information as measurement results of the power consumptions of the respective devices of the server system 101. It should be noted that the correspondences between the respective external sensors 103 to 121 and the respective devices of the server system 101 are set in advance.

In Step 603, the repository data processing module 110 stores the sensor information created in Step 602 into the sensor information repository 114 of the internal hard disk drive 113.

As a result of the above-mentioned processing, the measurements of the respective external sensors 103 to 121 are stored as sensor information for every predetermined period in the sensor information repository 114 of the internal hard disk drive 113.

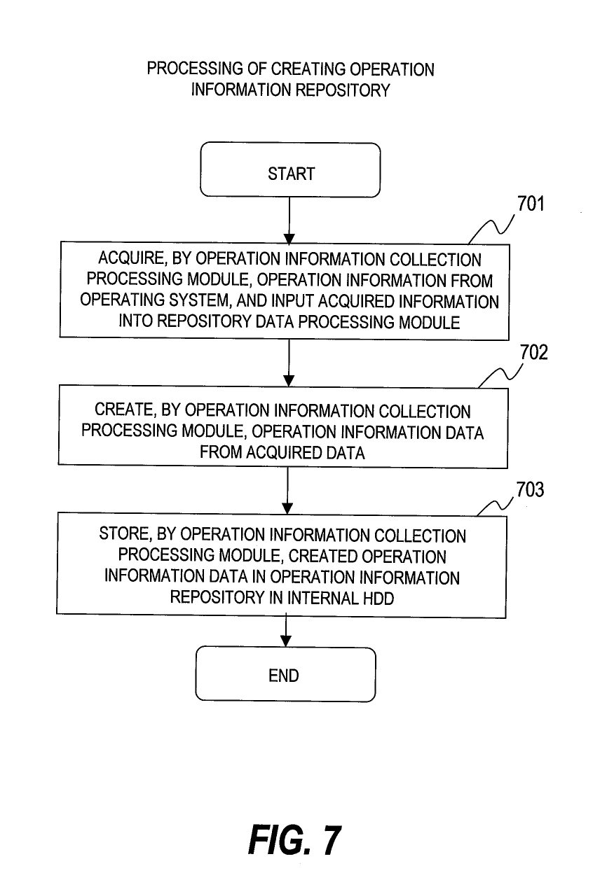

FIG. 7 is a flowchart illustrating an example of processing carried out on the operation information collection processing module 106. The operation information collection processing module 106 executes the processing represented by the flowchart of FIG. 7 for every predetermined period (such as one second).

In Step 701, the operation information collection processing module 106 acquires operation information set in advance from the OS 310. On this occasion, the operation information acquired from the OS 310 includes, as illustrated in FIG. 3, in this embodiment, a usage of the processor 102, a disk busy rate of the internal hard disk drive 113, and processor usages of the respective applications A 210 to C 212.

In Step 702, the operation information collection processing module 106 creates, from the operation information acquired by the operation information collection processing module 106 from the OS 310, operation information to be stored into the operation information repository 115 illustrated in FIG. 3. The operation information is created as one entry by adding a timestamp representing a time when the operation information has been acquired from the OS 310 to the operation information.

In Step 703, the operation information collection processing module 106 stores the operation information created in Step 702 into the operation information repository 115 of the internal hard disk drive 113.

As a result of the above-mentioned processing, the operation information acquired from the OS 310 is stored as operation information for every predetermined period into the operation information repository 115 of the internal hard disk drive 113.

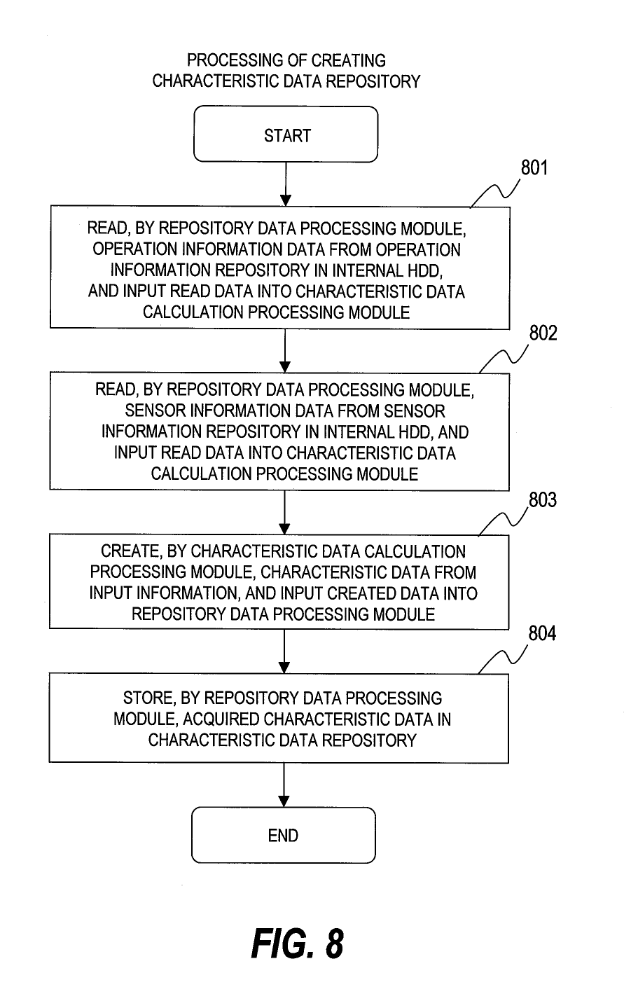

FIG. 8 is a flowchart illustrating an example of processing of creating the characteristic data, which is carried out by the repository data processing module 110 and the characteristic data calculation processing module 107. The processing of creating characteristic data, as described later, in a predetermined period (such as the test period of the server system 101), is carried out based on the sensor information and the operation information collected in the above-mentioned processing of FIGS. 6 and 7. This processing is carried out in a period and for types of applications which are specified by the administrator of the server system 101 or the like.

In Step 801, the repository data processing module 110 receives the period and the types of applications for information for which characteristic data is to be created from an input device (not shown), reads operation information in the specified period from the operation information repository 115, and inputs the read operation information into the characteristic data calculation processing module 107.

Next, in Step 802, the repository data processing module 110 reads the sensor information in the specified period from the sensor information repository 114, and inputs the read sensor information into the characteristic data calculation processing module 107.

In Step 803, the characteristic data calculation processing module 107 calculates, from the operation information and sensor information input in Steps 801 and 802, by means of a publicly known method such as the regression analysis, characteristic data of the specified applications. The characteristic data calculation processing module 107 notifies the repository data processing module 110 of the calculated characteristic data.

In Step 804, the repository data processing module 110 stores the characteristic data of the specified applications received from the characteristic data calculation processing module 107 into the characteristic data repository 116 of the internal hard disk drive 113.

As a result of the above-mentioned processing, pieces of the characteristic data are obtained for the respective applications A 210 to C 212 and are stored into the characteristic data repository 116, and, after the respective applications A 210 to C 212 become in operation, the failure symptom determination processing module 108 and the like refer to the characteristic data for the respective applications in the characteristic data repository 116.

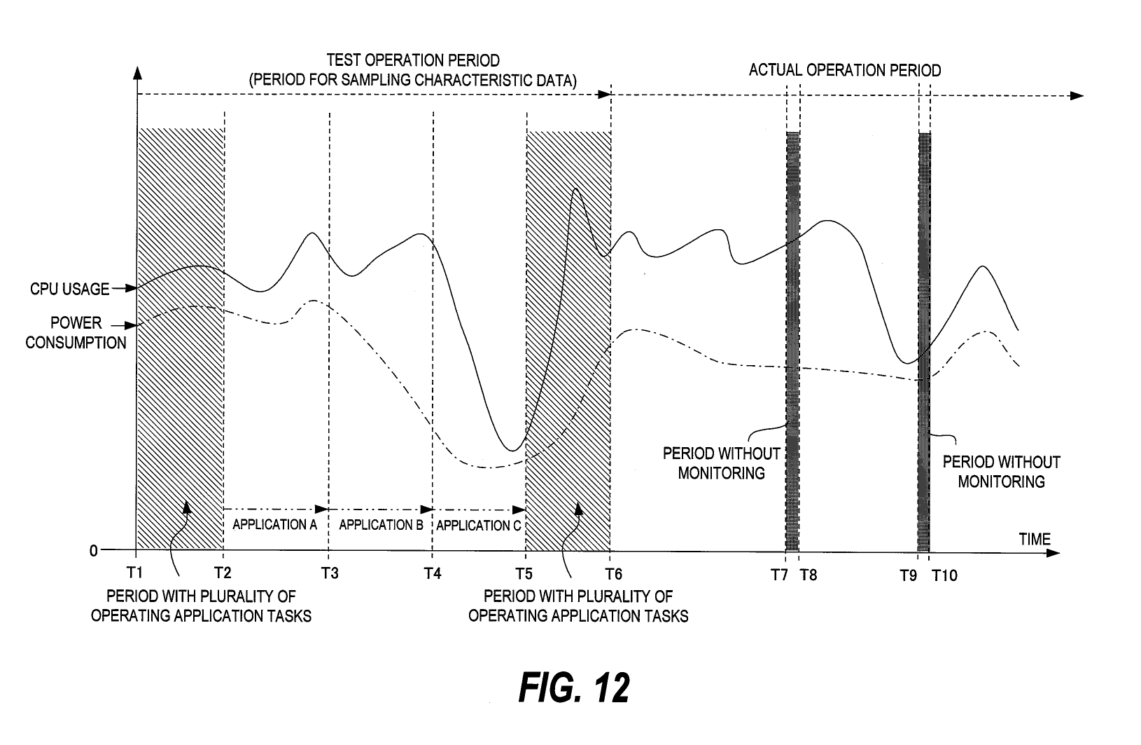

On this occasion, pieces of data for calculating the characteristic data are acquired as illustrated in FIG. 12. FIG. 12 is a chart illustrating relationships between the processor usage of the application A 210 and time, and between the power consumption of the application A 210 and time.

In FIG. 12, a period from time T1 to T6 represents a test operation period of the server system 101. In this period, the operation information and the sensor information are collected as illustrated in FIG. 7 and FIG. 6, and, before the actual operation period starts from the time T6, the processing of calculating the characteristic data illustrated in FIG. 8 is carried out, thereby calculating the characteristic data for the respective applications to be stored into the characteristic data repository 116.

In the test operation period, in periods from T1 to T2 and T5 to T6, the plurality of applications A 210 to C 212 are executed on the server system 101, and hence, in order to improve the precision of the characteristic data, it is preferable for the calculation of the characteristic data to exclude the operation information and sensor information in the periods in which the plurality of applications are executed.

For calculating the characteristic data, pieces of data (sensor information and operation information) in periods in which the each of the applications A 210 to C 212 operates solely are used. For example, when the characteristic data for the application A 210 is calculated, the sensor information and the operation information in the period from the time T2 to the time T3 in which the application A 210 is solely executed are used.

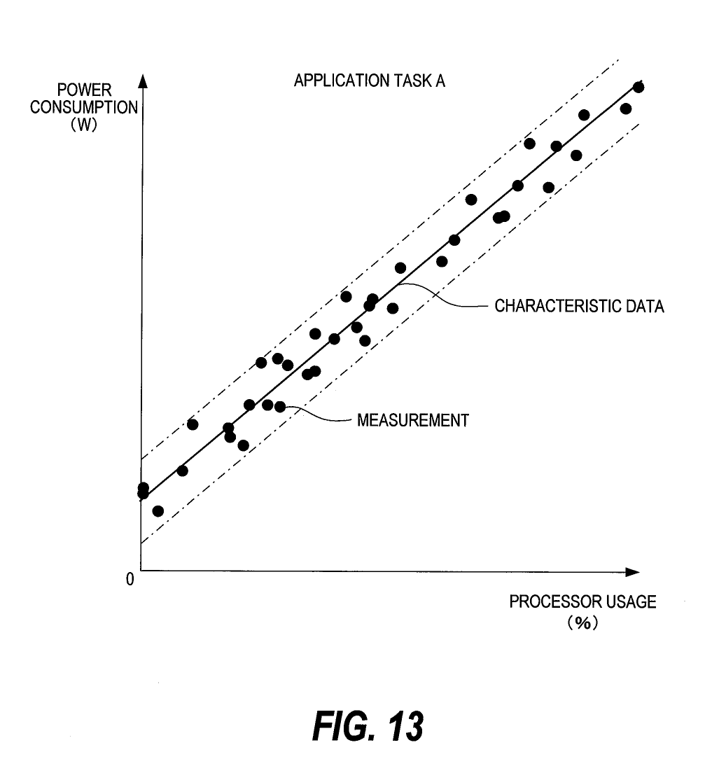

The characteristic data calculation processing module 107 acquires the operation information and the sensor information for the application A 210 in the period from the time T2 to the time T3 from the repository data processing module 110, and produces pairs of the operation information and the sensor information which have the timestamps matching each other (or closest to each other). For example, as illustrated in FIG. 13, when the characteristic data of the power consumption of the processor 102 for the application A 210 is to be created, the processor usage of the application task A in the operating application task information 304 of the operation information illustrated in FIG. 3 and the processor power consumption 202 of the processor 102 in the sensor information illustrated in FIG. 2, which have the timestamps matching each other or closest to each other, are paired, thereby generating relationships between the processor usage of the application task A and the power consumption of the processor 102 for respective timestamps. As a result, in FIG. 13, the relationships between the processor usage of the application A 210 and the power consumption of the processor 102 are represented by the dots. It should be noted that FIG. 13 is a chart indicating the characteristic data of the application A 210, and the relationship between the processor usage and the power consumption.

Then, the characteristic data calculation processing module 107 obtains the characteristic data of the processor power consumption 402 with respect to the processor usage based on the relationship between the processor usage of the application A 210 and the power consumption of the processor 102 which are acquired from the plurality of pieces of the operation information and the sensor information in the period from the time T2 to the time T3 by means of the regression analysis. The relationship between the processor usage and the processor power consumption 402 for the application A 210 is represented by the characteristic data, which is a solid line of FIG. 13. It should be noted that the calculation of the characteristic data is not limited to the regression analysis, and may be carried out by means of a publicly known method. Then, the power consumptions of the processor 102 obtained by the characteristic data calculation processing module 107 are associated with the processor usages, and are stored into the characteristic data repository 116 illustrated in FIG. 4. It should be noted that the characteristic data repository 116 is created for the respective types of the applications A 210 to C 212.

Similarly, the characteristic data calculation processing module 107 calculates characteristic data for the power consumption of the storage system 104 with respect to the processor usage, characteristic data for the power consumption of the internal hard disk drive 113 with respect to the processor usage, characteristic data for the power consumption of the chipset 120 with respect to the processor usage, and characteristic data for the power consumption of the power supply device 118 with respect to the processor usage when the application A 210 is executed, and stores the calculated characteristic data into the characteristic data repository 116.

As a result of the above-mentioned processing, based on the operation information and the sensor information in the test operation period, pieces of the characteristic data of the application A 210 are obtained, and are stored into the characteristic data repository 116.

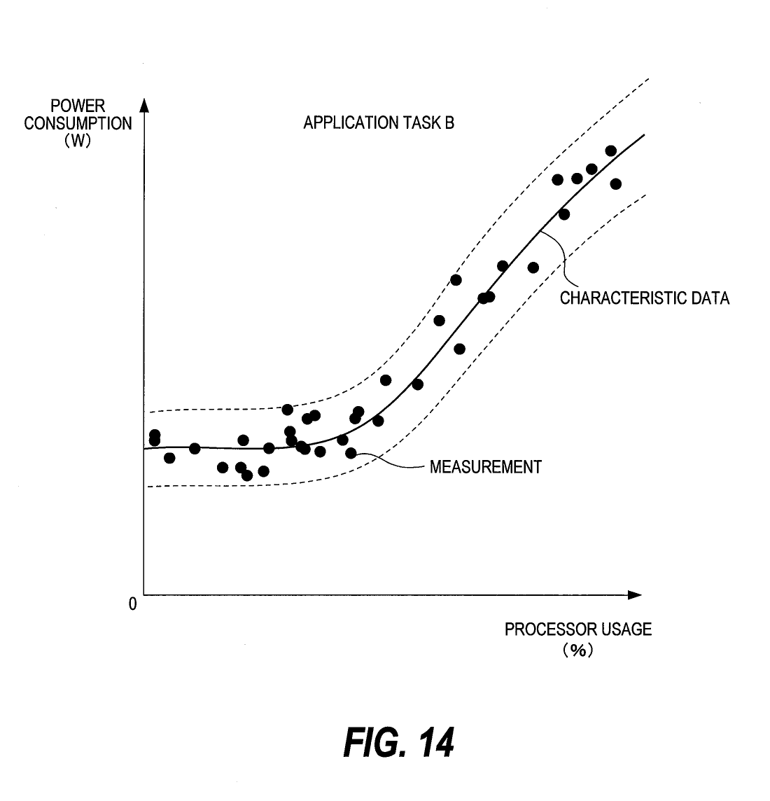

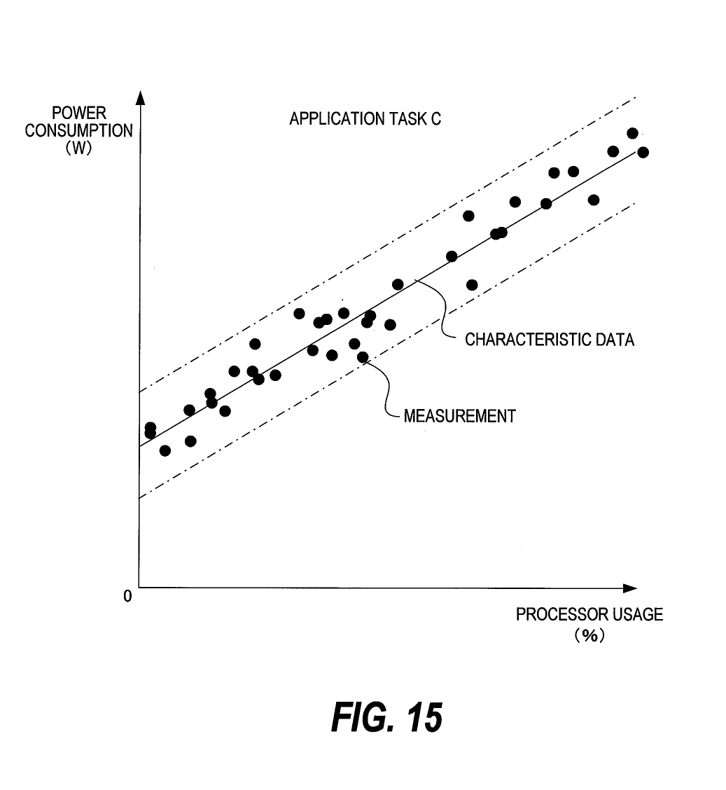

For the applications B 211 and C 212 executed on the server system 101, as described above, pieces of the characteristic data are obtained based on the operation information and the sensor information in respective periods from the time T3 to the time T4 and from the time T4 to the time T5 in the test operation period, and are stored into the characteristic data repository 116 for the respective applications B 211 and C 212. As an example, the relationship between the processor usage and the processor power consumption 402 when the application B 211 is executed as illustrated in FIG. 14, and the relationship between the processor usage and the processor power consumption 402 when the application C 212 is executed as illustrated in FIG. 15. It should be noted that FIG. 14 is a chart indicating the characteristic data of the application B 211, and the relationship between the processor usage and the power consumption.

As described above, pieces of the characteristic data for the applications A 210 to C 212 created by the characteristic data calculation processing module 107 based on the operation information and the sensor information in the test operation period are stored into the characteristic data repository 116.

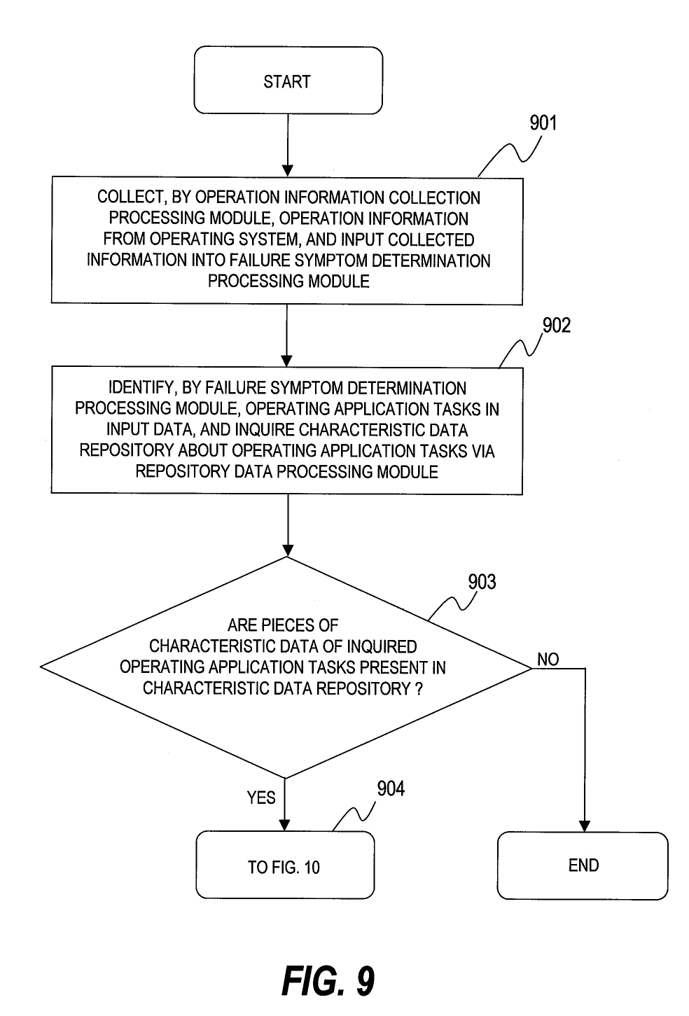

Then, in the actual operation period starting from the time T6 illustrated in FIG. 12, the failure symptom determination processing module 108 detects a symptom of failure of the server system 101 based on the characteristic data for the respective applications A 210 to C 212 stored in the characteristic data repository 116. It should be noted that FIG. 12 is a chart indicating relationships between the processor usage and time, and between the power consumption and time when the applications A 210 to C 212 are executed. FIGS. 9 to 11 are flowcharts illustrating an example of processing carried out by the failure symptom detection module 10.

The example of processing illustrated in the flowcharts of FIGS. 9 to 11 is carried out by the failure symptom detection module 10 in the actual operation period. The processing illustrated in FIGS. 9 to 11 is executed for every predetermined period (such as one second).

FIG. 9 is a flowchart illustrating an example of a first part of the processing carried out by the failure symptom detection module 10 in the actual operation period of the server system 101. In Step 901 of FIG. 9, the operation information collection processing module 106 acquires the operation information from the OS 310, and inputs the obtained operation information into the failure symptom determination processing module 108. The operation information obtained from the OS 310 is the operation information set in advance as described above, and includes, out of the information stored in the operation information repository 115 illustrated in FIG. 3, at least the operating application task information 304.

In Step 902, the failure symptom determination processing module 108 identifies operating applications (application tasks) from the input operation information. The failure symptom determination processing module 108 refers, via the repository data processing module 110, to the applications stored in the characteristic data repository 116. It should be noted that the failure symptom determination processing module 108 may identify the applications based on process names and process IDs managed by the OS 310.

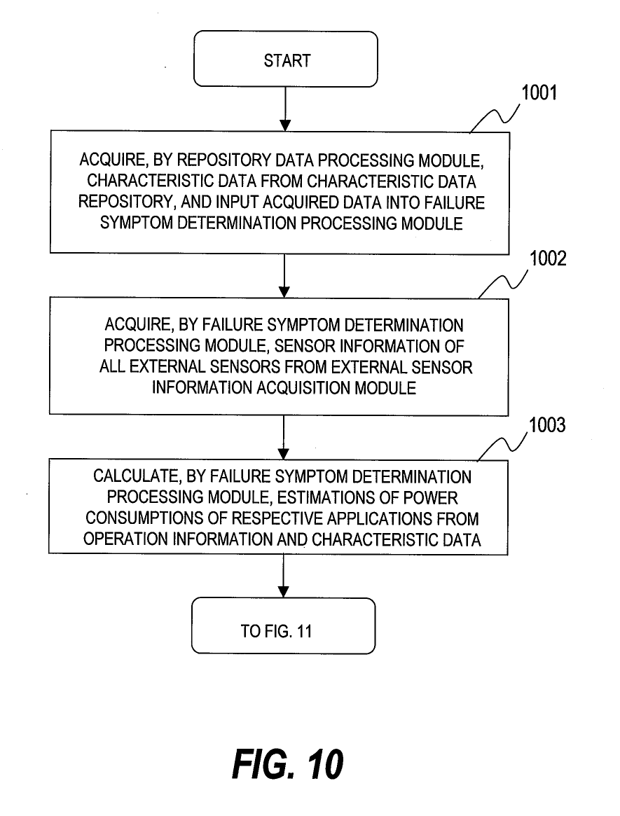

In Step 903, the failure symptom determination processing module 108 determines whether or not pieces of characteristic data corresponding to the applications running on the OS 310, which are identified in Step 902, are stored in the characteristic data repository 116. When pieces of characteristic data corresponding to the operating applications are not present, the failure symptom determination processing module 108 finishes the processing, and when pieces of characteristic data corresponding to all the operating applications are present, the failure symptom determination processing module 108 proceeds to processing of FIG. 10. When pieces of characteristic data corresponding to the operating applications are not present, it is difficult to precisely estimate the power consumptions of the respective devices corresponding to the processor usage for the respective applications A 210 to C 212, and hence the determination of failure symptom is prohibited in a period in which an application having no characteristic data and a command therefor are being executed. This period corresponds, for example, to periods without monitoring from T7 to T8, and from T9 to T10 as illustrated in FIG. 12. In those periods without monitoring from T7 to T8, and from T9 to T10, it is expected, for example, that the server system 101 is in an operation status such as periodical system maintenance carried out by the administrator of the server system 101, which is different from the operation status for operation of an application task.

Next, FIG. 10 is a flowchart illustrating an example of a middle part of the processing carried out by the failure symptom detection module 10 in the actual operation period of the server system 101. In Step 1001 of FIG. 10, the repository data processing module 110 acquires the characteristic data of the applications identified in Step 902 from the characteristic data repository 116, and inputs the acquired characteristic data into the failure symptom determination processing module 108.

In Step 1002, the failure symptom determination processing module 108, by requesting the external sensor information acquisition module 112 for the information of all the external sensors, acquires the sensor information of the respective external sensors 103 to 121.

In Step 1003, the failure symptom determination processing module 108 obtains, from the operation information acquired in Step 901, estimations of the power consumptions of the respective devices of the server system 101.

The failure symptom determination processing module 108 acquires, by referring to the operating application task information on the respective operating applications out of the operation information, the processor usages of the respective currently operating applications. Then, the failure symptom determination processing module 108 refers to the characteristic data for the respective applications acquired from the characteristic data repository 116, thereby obtaining estimations of the power consumption for the respective devices corresponding to the processor usage of the respective applications.

For example, when the acquired operation information is a value indicated in a first entry (time: 12:00:01) in the operation information repository 115 of FIG. 3, the processor usage of the application A 210 is 30%, and the processor usage of the application B 211 is 50%.

From the characteristic data when the processor usage of the application A 210 is 30%, the estimations of power consumption of the respective devices are represented as follows:

Estimation of power consumption of the processor 102: EPcpu(A)=40 watts;

Estimation of power consumption of the storage system 104: EPmem(A)=10 watts;

Estimation of power consumption of the internal hard disk drive 113: EPhdd (A)=10 watts;

Estimation of power consumption of the chipset 120: EPtip(A)=15 watts; and

Estimation of power consumption of the power supply device 118: EPpwr(A)=75 watts.

A suffix “(A)” is an identifier of the application A 210.

At this time point 12:00:01, the application B 211 is also running. Hence, the failure symptom determination processing module 108 obtains the estimations of the power consumption for the respective devices corresponding to the processor usage of the application B 211 of 50% from the characteristic data in the characteristic data repository 116, and sets the estimations as the estimation EPcpu(B) of the power consumption of the processor 102, the estimation EPmem(B) of the power consumption of the storage system 104, the estimation EPhdd(B) of the power consumption of the internal hard disk drive 113, the estimation EPtip(B) of the power consumption of the chipset 120, and the estimation of EPpwr(B) of the power consumption power supply device 118.

Then, the failure symptom determination processing module 108 sums the estimations of the power consumption of the respective devices obtained for the respective applications. When there are applications from A to n, the estimations of the power consumption of the respective devices of the server system 101 are represented by:

Estimation of power consumption of the processor 102: EPcpu=EPcpu (A)+EPcpu (B)+, . . . , +EPcpu(n);

Estimation of power consumption of the storage system 104: EPmem=EPmem(A)+EPmem(B)+, . . . , +EPmem(n);

Estimation of power consumption of the internal HDD 113: EPhdd=EPhdd(A)+EPhdd(B)+, . . . , +EPhdd(n);

Estimation of power consumption of the chipset 120: EPtip=EPtip(A)+EPtip(B)+, . . . , +EPtip(n); and

Estimation of power consumption of the power supply device 118: EPpwr=EPpwr(A)+EPpwr(B)+, . . . , +EPpwr(n).

In this way, the failure symptom determination processing module 108 refers to the characteristic data based on the acquired operation information, thereby obtaining, in real time, the estimations of the status quantities (power consumptions in this embodiment) of the respective devices for the respective applications, and comparing the obtained estimations with the current values of the status quantities of the respective devices as in processing starting from Step 1101.

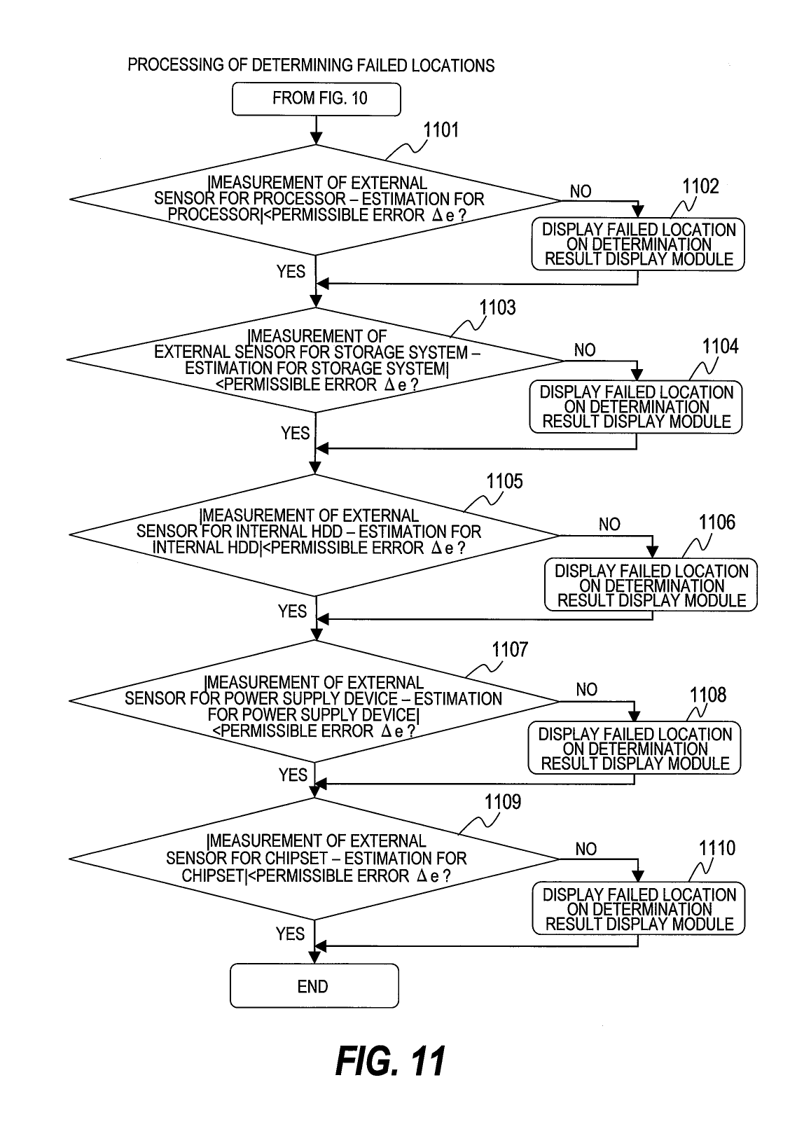

Next, FIG. 11 is a flowchart illustrating an example of a last part of the processing carried out by the failure symptom detection module 10 in the actual operation period of the server system 101. In Step 1101 of FIG. 11, the failure symptom determination processing module 108 determines whether or not an absolute value of a difference between the measurement of the external sensor 103 for the processor 102 and the estimation EPcpu of the power consumption of the processor 102 obtained in Step 1003 is less than the predetermined permissible error Δe. When the absolute value of the difference is less than the predetermined permissible error Δe, the failure symptom determination processing module 108 determines that the power consumption of the processor 102 is normal, and proceeds to Step 1103. On the other hand, when the absolute value of the difference is equal to or more than the predetermined permissible error Δe, the failure symptom determination processing module 108 determines that a symptom of failure has occurred, and proceeds to Step 1102. In Step 1102, the failure symptom determination processing module 108 notifies the failed location determination processing module 109 of the fact that the symptom of failure is present in the processor 102, and the failed location determination processing module 109 notifies the determination result display module 111 of the fact that the location in which the symptom of failure is present is the processor 102. Then, the processing proceeds to Step 1103.

Next, in Step 1103, the failure symptom determination processing module 108 determines whether or not an absolute value of a difference between the measurement of the external sensor 105 for the storage system 104 and the estimation EPmem of the power consumption of the storage system 104 obtained in Step 1003 is less than the predetermined permissible error Δe. When the absolute value of the difference is less than the predetermined permissible error Δe, the failure symptom determination processing module 108 determines that the power consumption of the storage system 104 is normal, and proceeds to Step 1105. On the other hand, when the absolute value of the difference is equal to or more than the predetermined permissible error Δe, the failure symptom determination processing module 108 determines that a symptom of failure has occurred, and proceeds to Step 1104. In Step 1104, the failure symptom determination processing module 108 notifies the failed location determination processing module 109 of the fact that the symptom of failure is present in the storage system 104, and the failed location determination processing module 109 notifies the determination result display module 111 of the fact that the location in which the symptom of failure is present is the storage system 104. Then, the processing proceeds to Step 1105.

Next, in Step 1105, the failure symptom determination processing module 108 determines whether or not an absolute value of a difference between the measurement of the external sensor 117 for the internal hard disk drive 113 and the estimation EPhdd of the power consumption of the internal hard disk drive 113 obtained in Step 1003 is less than the predetermined permissible error Δe. When the absolute value of the difference is less than the predetermined permissible error Δe, the failure symptom determination processing module 108 determines that the power consumption of the internal hard disk drive 113 is normal, and proceeds to Step 1107. On the other hand, when the absolute value of the difference is equal to or more than the predetermined permissible error Δe, the failure symptom determination processing module 108 determines that a symptom of failure has occurred, and proceeds to Step 1106. In Step 1106, the failure symptom determination processing module 108 notifies the failed location determination processing module 109 of the fact that the symptom of failure is present in the internal hard disk drive 113, and the failed location determination processing module 109 notifies the determination result display module 111 of the fact that the location in which the symptom of failure is present is the internal hard disk drive 113. Then, the processing proceeds to Step 1107.

Next, in Step 1107, the failure symptom determination processing module 108 determines whether or not an absolute value of a difference between the measurement of the external sensor 119 for the power supply device 118 and the estimation EPpwr of the power consumption of the power supply device 118 obtained in Step 1003 is less than the predetermined permissible error Δe. When the absolute value of the difference is less than the predetermined permissible error Δe, the failure symptom determination processing module 108 determines that the power consumption of the power supply device 118 is normal, and proceeds to Step 1109. On the other hand, when the absolute value of the difference is equal to or more than the predetermined permissible error Δe, the failure symptom determination processing module 108 determines that a symptom of failure has occurred, and proceeds to Step 1108. In Step 1108, the failure symptom determination processing module 108 notifies the failed location determination processing module 109 of the fact that the symptom of failure is present in the power supply device 118, and the failed location determination processing module 109 notifies the determination result display module 111 of the fact that the location in which the symptom of failure is present is the power supply device 118. Then, the processing proceeds to Step 1109.

Next, in Step 1109, the failure symptom determination processing module 108 determines whether or not an absolute value of a difference between the measurement of the external sensor 121 for the chipset 120 and the estimation EPtip of the power consumption of the chipset 120 obtained in Step 1003 is less than the predetermined permissible error Δe. When the absolute value of the difference is less than the predetermined permissible error Δe, the failure symptom determination processing module 108 determines that the power consumption of the chipset 120 is normal, and finishes the processing. On the other hand, when the absolute value of the difference is equal to or more than the predetermined permissible error Δe, the failure symptom determination processing module 108 determines that a symptom of failure has occurred, and proceeds to Step 1110. In Step 1110, the failure symptom determination processing module 108 notifies the failed location determination processing module 109 of the fact that the symptom of failure is present in the chipset 120, and the failed location determination processing module 109 notifies the determination result display module 111 of the fact that the location in which the symptom of failure is present is the chipset 120. Then, the processing is finished.

As a result of the above-mentioned processing, when the absolute value of the difference between the sum of the estimations of the status quantities of the each device obtained based on the current load information (processor usage) of the processor 102 and the characteristic data for the respective applications A 210 to C 212 obtained in advance, and the current value of the status quantity of the each device measured by each of the external sensors 103 to 121 exceeds the permissible error Δe, the failure symptom determination processing module 108 determines that a symptom of failure is present, and causes the determination result display module 111 to display a location (device) having the symptom of the failure via the failed location determination processing module 109.

As a result, it is possible to detect a symptom of failure according to the characteristics of the applications before the failure actually occurs for the respective devices constituting the server system 101, and moreover, detect an unknown symptom of failure in addition to a symptom of failure expected in advance, which can also be detected by the above-mentioned conventional example. In particular, before a failure occurs in the hardware of the server system 101 due to a change over time, a symptom of failure can be detected according to the characteristics of the applications, and further, a location having the symptom of failure can be identified, and hence the server system 101 can be easily maintained.

Though, in the above-mentioned embodiment, the one permissible error Δe is used to determine whether the respective devices or locations have a symptom of failure, predetermined permissible errors may be set for the respective devices.

Moreover, in the above-mentioned embodiment, the sensors for measuring power consumptions are employed as the external sensors 103 to 121, but, as the external sensors 103 to 121, temperature sensors, vibration sensors (acceleration sensors), or rotation speed sensors for measuring rotation speeds of cooling fans and the like may be employed.

Moreover, all the external sensors 103 to 121 may not be of the same type, and different types of sensors may be employed for the respective devices. For example, the processor 102 may be provided with a sensor for measuring the power consumption, a sensor for measuring the temperature, and a rotation speed sensor for measuring the rotation speed of a cooling fan of the processor 102, and the internal hard disk drive 113 may be provided with a temperature sensor and a vibration sensor. In this case, the permissible error Δe may be set for the respective types of the sensors.

Moreover, the external sensors 103 to 121 for measuring the status quantities of the respective devices of the server system 101 are not limited to sensors attached to the respective devices of the server system 101, but may be sensors integrated into the respective devices. For example, measurements of a temperature sensor integrated into the processor 102, a rotation speed sensor and a temperature sensor integrated into the internal hard disk drive 113, a temperature sensor integrated into the chipset 120, and the like may be used.

Moreover, according to this embodiment, the characteristic data in the characteristic data repository 116 contains the status quantities (power consumptions) of the respective devices with the processor usage as an index of the load information, but the disk busy rate and other load information which can be detected from the server system 101 may be used as the index. Moreover, according to this embodiment, pieces of the characteristic data in the characteristic data repository 116 are stored as the map, but the characteristic data may be stored as functions and the like.

### Second Embodiment

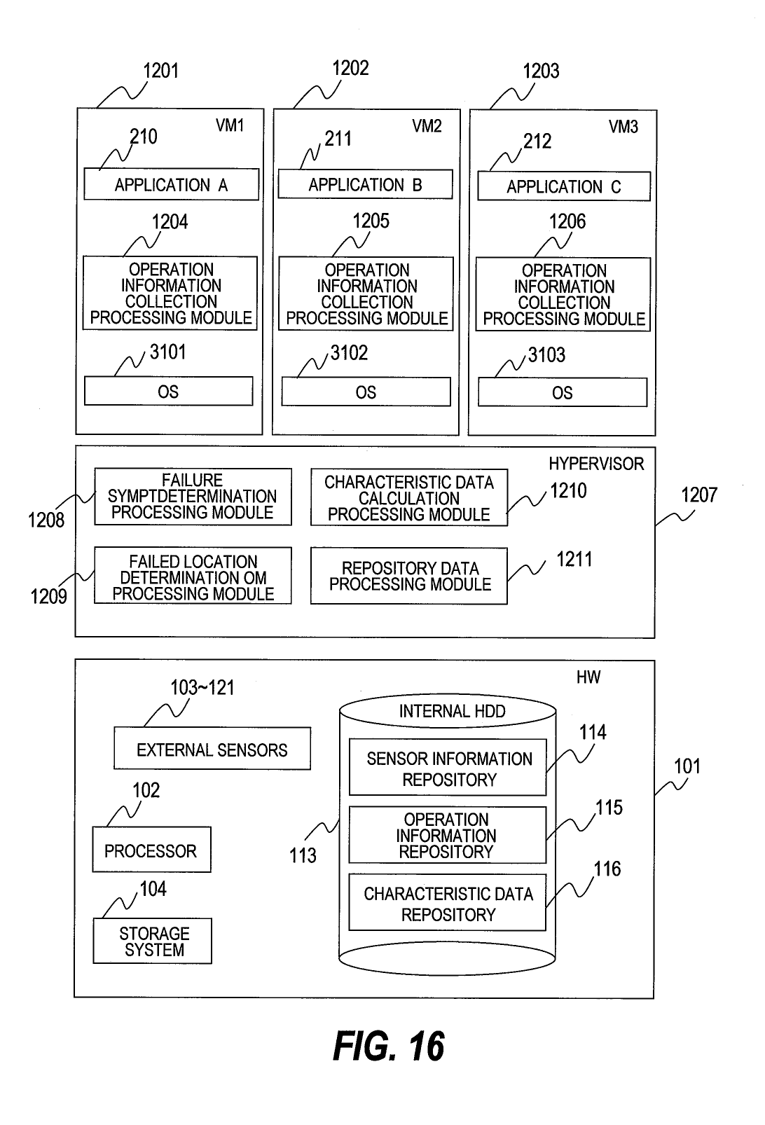

FIG. 16 is a block diagram of a server system according to a second embodiment. According to the second embodiment, on the server system 101 according to the first embodiment, a plurality of virtual computers 1201 to 1203 operate, and, as a virtualization module for managing the virtual computers 1201 to 1203, a hypervisor 1207 is executed. It should be noted that the hardware configuration of the server system 101 is the same as that of the first embodiment. The hypervisor 1207 and the respective virtual computers 1201 to 1203 are loaded to the storage system 104, and are executed by the processor 102. The hardware configuration of the server system 101 is the same as that of the first embodiment illustrated in FIG. 1, and, in FIG. 16, only main components are illustrated, and the other components are omitted.

The hypervisor 1207 logically splits hardware resources of the server system 101, thereby creating the virtual computers 1201 to 1203. On the respective virtual computers 1201 to 1203, OSes 3101 to 3103 respectively operate, and, on the respective OSes 3101 to 3103, operation information collection processing modules 1204 to 1206 for detecting operation statuses of applications are respectively executed. Moreover, on the respective virtual computers 1201 to 1203, the applications A 210 to C 212 are respectively executed.

Functions of the operation information collection processing modules 1204 to 1206 operating on the respective virtual computers 1201 to 1203, are the same as those of the operation information collection processing module 106 according to the first embodiment, and the operation information collection processing modules 1204 to 1206 acquire, for every predetermined period (such as one second) from the OSes 3101 to 3103, the processor usage indicating the usage of the processors, the disk busy rate indicating the usage of the internal hard disk drive 113, and the processor usages by the respective applications A 210 to C 212, and stores those pieces of operation information in the operation information repository 115. The processor usages acquired by the respective operation information collection processing modules 1204 to 1206 from the OSes 3101 to 3103 represent usages of virtual processors assigned by the hypervisor 1207 to the virtual computers 1201 to 1203, and the disk busy rates acquired by the respective operation information collection processing modules 1204 to 1206 from the OSes 3101 to 3103 are values for virtual I/Os provided by the hypervisor 1207 to the virtual computers 1201 to 1203.

The hypervisor 1207 includes a failure symptom determination processing module 1208, a failed location determination processing module 1209, a characteristic data calculation processing module 1210, and a repository data processing module 1211.

The repository data processing module 1211, in the same manner as the repository data processing module 110 according to the first embodiment, acquires information (measurements) of the external sensors 103 to 121, and stores the acquired information in the internal hard disk drive 113.

The characteristic data calculation processing module 1210, in the same manner as the characteristic data calculation processing module 107 according to the first embodiment, according to the types of the applications running on the virtual computers 1201 to 1203, calculates the characteristic data, and stores the calculated characteristic data in the characteristic data repository 116 of the internal hard disk drive 113. According to the second embodiment, the processor usage in the characteristic data repository 116 illustrated in FIG. 4 is the processor usage of the virtual processor assigned by the hypervisor 1207 to the virtual computers 1201 to 1203.

The failure symptom determination processing module 1208, in the same manner as the failure symptom determination processing module 108 according to the first embodiment, detects, based on the information from the external sensors 103 to 121 acquired by the repository data processing module 1211, the information on the operation statuses of the applications acquired by the operation information collection processing modules 1204 to 1206, and the characteristic data in the characteristic data repository 116 set for the respective applications, a symptom of failure of the server system 101.

The failed location determination processing module 1209, in the same manner as the failed location determination processing module 109 according to the first embodiment, identifies, when the failure symptom determination processing module 1208 detects a symptom of failure in the server system 101, a location in the server system 101 having the symptom of failure.

The failure symptom determination processing module 1208, as in the first embodiment, based on the virtual processor usages acquired from the respective OSes 3101 to 3103 by the operation information collection processing modules 1204 to 1206 of the respective virtual computers 1201 to 1203, obtains, from the respective characteristic data of the applications A 210 to C 212, the estimations of the status quantities of the respective devices of the server system 101. Moreover, the failure symptom determination processing module 1208 obtains, from the external sensors 103 to 121, the current values of the status quantities of the respective devices. Then, the failure symptom determination processing module 1208 determines, when, for the respective devices, the absolute value of the difference between the current value and the estimation of the status quantity is equal to or larger than the predetermined permissible error Δe, that a symptom of failure occurs.

In addition, according to the second embodiment, as in the first embodiment, based on the usages of the virtual processors for the respective applications operating on the virtual computers 1201 to 1203, from the characteristic data set in advance, by obtaining the estimations of the status quantities of the respective devices, and by respectively comparing the estimations with the current values of the status quantities, it is possible to, according to the characteristic of the applications, properly determine a symptom of failure of the server system 101. As a result, even when the server system 101 runs the virtual computers 1201 to 1203, as in the first embodiment, it is possible to detect a symptom of hardware failure caused by a change over time, and to identify a location having the symptom of failure, resulting in easy maintenance of the server system 101.

It should be noted that, according to the first and second embodiments, the examples in which the failure symptom determination processing module 108, the failed location determination processing module 109, and the characteristic data repository 116 are situated on the same computer are described, but the computer system is not limited to those examples, and the computer system may be constructed such that, for example, the failure symptom determination processing module 108 and the failed location determination processing module 109 are executed on a second computer connected via a network, and, in the storage system connected via a storage area network (SAN) to the second computer and the server system 101, the characteristic data repository 116 may be stored.

As described above, this invention can be applied to a computer system and a computer offering applications and services, and moreover, to software for monitoring a symptom of hardware failure of a computer.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a computer comprising:
a processor for carrying out an arithmetic operation; and
a memory for storing an application and an OS which are executed by the processor;
a plurality of sensors each provided to a component of hardware of the computer, for measuring a status quantity of the component; and
a failure symptom detection unit for detecting a symptom of a failure in the hardware based on a measurement of each of the plurality of sensors,
wherein the failure symptom detection unit comprises:
an operation information acquisition unit for acquiring, from the OS, load information on the processor used for the application;
a sensor information processing unit for acquiring the measurement from the each of the plurality of sensors for each component;
a characteristic data storage unit for associating, in advance, each load information on the processor when the application is executed and the measurement of the each of the plurality of sensors for the each component when the application is executed with each other, and storing the associated load information and the associated measurement as characteristic information on the application;
a failure symptom determination processing unit for obtaining, from current load information acquired by the operation information acquisition unit and the characteristic information corresponding to the application, an estimation of the status quantity of the each component, which corresponds to the current load information, obtaining, from the sensor information processing unit, a current status quantity as a current value for the each component, and comparing, for the each component, an absolute value of a difference between the estimation and the current value with a permissible error set in advance, to thereby determine, when the absolute value of the difference is equal to or more than the permissible error, that the symptom of the failure is present; and
a failed location determination processing unit for identifying the component having the absolute value of the difference equal to or more than the permissible error as a component in which the symptom of the failure is present.

2. The computer system according to claim 1, wherein:
the processor executes a plurality of the applications;
the operation information acquisition unit acquires the load information on the processor used for each of the plurality of the applications;
the characteristic data storage unit stores the characteristic information corresponding to the each of the plurality of the applications; and
the failure symptom determination processing unit obtains, from the current load information acquired for the each of the plurality of the applications by the operation information acquisition unit and the characteristic information corresponding to the each of the plurality of the applications, the estimation of the status quantity of the each component, which corresponds to the current load information for the each of the plurality of the applications, obtains a sum of the estimations obtained for the each of the plurality of the applications, and, from the sensor information processing unit, the current status quantity as the current value for the each component, and compares, for the each component, an absolute value of a difference between the sum of the estimations and the current value with the permissible error set in advance, to thereby determine, when the absolute value of the difference is equal to or more than the permissible error, that the symptom of the failure is present.

3. The computer system according to claim 1, wherein:
the processor executes a virtualization module for providing a virtual computer with a virtual processor so that the application is executed by the virtual computer;
the operation information acquisition unit acquires load information on the virtual processor used for the application; and
the characteristic data storage unit associates, in advance, each load information on the virtual processor when the application is executed and the measurement of the each of the plurality of sensors for the each component when the application is executed with each other, and stores the associated load information and the associated measurement as the characteristic information on the application.

4. The computer system according to claim 2, wherein:
the processor executes a virtualization module for providing each of a plurality of virtual computers with a virtual processor so that the each of the plurality of the applications is executed by the each of the plurality of virtual computers;
the operation information acquisition unit acquires load information on the virtual processor used for the each of the plurality of the applications; and
the characteristic data storage unit associates, for the each of the plurality of the applications in advance, each load information on the virtual processor when the each of the plurality of the applications is executed and the measurement of the each of the plurality of sensors for the each component when the each of the plurality of the applications is executed with each other, and stores the associated load information and the associated measurement as the characteristic information on the each of the plurality of the applications.

5. The computer system according to claim 1, wherein the failure symptom determination processing unit identifies an application corresponding to the load information on the processor, which is acquired by the operation information acquisition unit, and, when the characteristic information on the identified application is not present in the characteristic data storage unit, prohibits the comparison of, for the each component, the absolute value of the difference between the estimation and the current value with the permissible error set in advance.

6. A method of detecting a symptom of a failure in a computer system comprising:
a computer comprising:
a processor for carrying out an arithmetic operation; and
a memory for storing an application and an OS which are executed by the processor; and
a plurality of sensors each provided to a component of hardware of the computer, for measuring a status quantity of the component,
the symptom of the failure in the hardware being detected based on a measurement of each of the plurality of sensors,
the method comprising:
acquiring, by the processor from the OS, load information on the processor used for the application when the processor executes the application;
acquiring, by the processor, the measurement of the each of the plurality of sensors for the each component when the processor executes the application;
associating, by the processor in advance, each load information when the application is executed and the measurement of the each of the plurality of sensors for the each component when the application is executed with each other, and storing, in a storage system, the associated load information and the associated measurement as characteristic information on the application;
acquiring, by the processor from the OS, current load information on the processor used for the application, and obtaining, from the characteristic information corresponding to the application, an estimation of the status quantity of the each component, which corresponds to the current load information;
acquiring, by the processor from the each of the plurality of sensors, a current status quantity as a current value for the each component;
comparing, by the processor for the each component, an absolute value of a difference between the estimation and the current value with a permissible error set in advance, to thereby determine, when the absolute value of the difference is equal to or more than the permissible error, that the symptom of the failure is present; and
identifying, by the processor, the component having the absolute value of the difference equal to or more than the permissible error as a component in which the symptom of the failure is present.

7. The method of detecting a symptom of a failure in a computer system according to claim 6, wherein:
the processor executes a plurality of the applications;
the acquiring, by the processor from the OS, the load information on the processor used for the application when the processor executes the application comprises acquiring the load information on the processor used for each of the plurality of the applications;
the associating, by the processor in advance, the each load information when the application is executed and the measurement of the each of the plurality of sensors for the each component when the application is executed with each other, and storing, in the storage system, the associated load information and the associated measurement as the characteristic information on the application comprises storing the characteristic information corresponding to the each of the plurality of the applications;
the acquiring, by the processor from the OS, the current load information on the processor used for the application, and obtaining, from the characteristic information corresponding to the application, the estimation of the status quantity of the each component, which corresponds to the current load information comprises obtaining, from the current load information acquired for the each of the plurality of the applications and the characteristic information corresponding to the each of the plurality of the applications, the estimation of the status quantity of the each component, which corresponds to the current load information for the each of the plurality of the applications, and obtaining a sum of the estimations obtained for the each of the plurality of the applications; and
the comparing, by the processor for the each component, the absolute value of the difference between the estimation and the current value with the permissible error set in advance, to thereby determine, when the absolute value of the difference is equal to or more than the permissible error, that the symptom of the failure is present comprises comparing, by the processor for the each component, an absolute value of a difference between the sum of the estimations and the current value with the permissible error set in advance, to thereby determine, when the absolute value of the difference is equal to or more than the permissible error, that the symptom of the failure is present.

8. The method of detecting a symptom of a failure in a computer system according to claim 6, wherein:
the processor executes a virtualization module for providing a virtual computer with a virtual processor so that the application is executed by the virtual computer;
the processor acquires load information on the virtual processor used for the application as the load information; and
the associating, by the processor in advance, the each load information when the application is executed and the measurement of the each of the plurality of sensors for the each component when the application is executed with each other, and storing, in the storage system, the associated load information and the associated measurement as the characteristic information on the application comprises associating, in advance, each load information on the virtual processor when the application is executed and the measurement of the each of the plurality of sensors for the each component when the application is executed with each other, and storing, in the storage system, the associated load information and the associated measurement as the characteristic information on the application.

9. The method of detecting a symptom of a failure in a computer system according to claim 7, wherein:
the processor executes a virtualization module for providing each of a plurality of virtual computers with a virtual processor so that the each of the plurality of the applications is executed by the each of the plurality of virtual computers;
the processor acquires load information on the virtual processor used for the each of the plurality of the applications as the load information; and
the associating, by the processor in advance, the each load information when the application is executed and the measurement of the each of the plurality of sensors for the each component when the application is executed with each other, and storing, in the storage system, the associated load information and the associated measurement as the characteristic information on the application comprises associating, for the each of the plurality of the applications in advance, each load information on the virtual processor when the each of the plurality of the applications is executed and the measurement of the each of the plurality of sensors for the each component when the each of the plurality of the applications is executed with each other, and storing, in the storage system, the associated load information and the associated measurement as the characteristic information on the each of the plurality of the applications.

10. The method of detecting a symptom of a failure in a computer system according to claim 6, wherein the comparing, by the processor for the each component, the absolute value of the difference between the estimation and the current value with the permissible error set in advance, to thereby determine, when the absolute value of the difference is equal to or more than the permissible error, that the symptom of the failure is present comprises identifying an application corresponding to the load information on the processor, and, when the characteristic information on the identified application is not present in the storage system, prohibiting the comparing, for the each component, the absolute value of the difference between the estimation and the current value with the permissible error set in advance.

11. A machine-readable medium for storing a program for detecting a symptom of a failure in a computer system comprising:
a computer comprising:
a processor for carrying out an arithmetic operation; and
a memory for storing an application and an OS which are executed by the processor; and
a plurality of sensors each provided to a component of hardware of the computer, for measuring a status quantity of the component,
the symptom of the failure in the hardware being detected based on a measurement of each of the plurality of sensors,
the program controlling the computer to execute the procedures of:
acquiring, from the OS, load information on the processor used for the application when the application is executed;
acquiring the measurement of the each of the plurality of sensors for the each component when the application is executed;
associating, in advance, each load information when the application is executed and the measurement of the each of the plurality of sensors for the each component when the application is executed with each other, and storing, in a storage system, the associated load information and the associated measurement as characteristic information on the application;
acquiring, from the OS, current load information on the processor used for the application, and obtaining, from the characteristic information corresponding to the application, an estimation of the status quantity of the each component, which corresponds to the current load information;
acquiring, from the each of the plurality of sensors, a current status quantity as a current value for the each component;
comparing, for the each component, an absolute value of a difference between the estimation and the current value with a permissible error set in advance, to thereby determine, when the absolute value of the difference is equal to or more than the permissible error, that the symptom of the failure is present; and
identifying the component having the absolute value of the difference equal to or more than the permissible error as a component in which the symptom of the failure is present.

12. The machine-readable medium for storing a program according to claim 11, wherein:
the processor executes a plurality of the applications;
in the procedure of acquiring, from the OS, the load information on the processor used for the application when the application is executed, the load information on the processor used for each of the plurality of the applications is acquired;
in the procedure of associating, in advance, the each load information when the application is executed and the measurement of the each of the plurality of sensors for the each component when the application is executed with each other, and storing, in the storage system, the associated load information and the associated measurement as the characteristic information on the application, the characteristic information corresponding to the each of the plurality of the applications is stored;
in the procedure of acquiring, from the OS, the current load information on the processor used for the application, and obtaining, from the characteristic information corresponding to the application, an estimation of the status quantity of the each component, which corresponds to the current load information, from the current load information acquired for the each of the plurality of the applications and the characteristic information corresponding to the each of the plurality of the applications, the estimation of the status quantity of the each component, which corresponds to the current load information for the each of the plurality of the applications is obtained, and a sum of the estimations obtained for the each of the plurality of the applications is obtained; and
in the procedure of comparing, for the each component, the absolute value of the difference between the estimation and the current value with the permissible error set in advance, to thereby determine, when the absolute value of the difference is equal to or more than the permissible error, that the symptom of the failure is present, the processor compares, for the each component, an absolute value of a difference between the sum of the estimations and the current value with the permissible error set in advance, to thereby determine, when the absolute value of the difference is equal to or more than the permissible error, that the symptom of the failure is present.

13. The machine-readable medium for storing a program according to claim 11, wherein:
the processor executes a virtualization module for providing a virtual computer with a virtual processor so that the application is executed by the virtual computer;
as the load information, load information on the virtual processor used for the application is acquired; and
in the procedure of associating, in advance, the each load information when the application is executed and the measurement of the each of the plurality of sensors for the each component when the application is executed with each other, and storing, in the storage system, the associated load information and the associated measurement as the characteristic information on the application, each load information on the virtual processor when the application is executed and the measurement of the each of the plurality of sensors for the each component when the application is executed are associated with each other in advance, and the associated load information and the associated measurement are stored in the storage system as the characteristic information on the application.

14. The machine-readable medium for storing a program according to claim 12, wherein:
the processor executes a virtualization module for providing each of a plurality of virtual computers with a virtual processor so that the each of the plurality of the applications is executed by the each of the plurality of virtual computers;
as the load information, load information on the virtual processor used for the each of the plurality of the applications is acquired; and
in the procedure of associating, in advance, the each load information when the application is executed and the measurement of the each of the plurality of sensors for the each component when the application is executed with each other, and storing, in the storage system, the associated load information and the associated measurement as the characteristic information on the application, for the each of the plurality of the applications in advance, each load information on the virtual processor when the each of the plurality of the applications is executed and the measurement of the each of the plurality of sensors for the each component when the each of the plurality of the applications is executed are associated with each other, and the associated load information and the associated measurement are stored in the storage system as the characteristic information on the each of the plurality of the applications.

15. The machine-readable medium for storing a program according to claim 11, wherein, in the procedure of comparing, for the each component, the absolute value of the difference between the estimation and the current value with the permissible error set in advance, to thereby determine, when the absolute value of the difference is equal to or more than the permissible error, that the symptom of the failure is present, an application corresponding to the load information on the processor is identified, and, when the characteristic information on the identified application is not present in the storage system, the comparison of for the each component, the absolute value of the difference between the estimation and the current value with the permissible error set in advance is prohibited.
